(19) United States
(12) Patent Application Publication
(10) Pub. No.: US 2023/0069462 A1
(43) Pub. Date: Mar. 2, 2023

(54) APPLIANCE WITH AN INTERIOR UNLOCKING FEATURE

(71) Applicant: Haier US Appliance Solutions, Inc., Wilmington, DE (US)

(72) Inventors: Elaine Marie Arens, Louisville, KY (US); Ronald Fernandez, Louisville, KY (US)

(21) Appl. No.: 17/458,968

(22) Filed: Aug. 27, 2021

(51) Int. Cl. E05B 65/00; F25D 23/02; E05B 47/00

(52) U.S. Cl. CPC E05B 65/0053; F25D 23/028; E05B 47/0012; E05B 2047/0094

(57) ABSTRACT

An appliance includes a cabinet that defines an interior chamber. A door is mounted to the cabinet. A lock assembly is configured to selectively secure the door in a closed arrangement. The lock assembly includes a first latch arm rotatably mounted on the cabinet and a second latch arm rotatably mounted on the door. A handle is positioned within the interior chamber of the cabinet. The handle is coupled to one of the first and second latch arms such that the one of the first and second latch arms is rotatable with the handle. A motor is coupled to the other of the first and second latch arms such that the other of the first and second latch arms is rotatable with the motor.

### FIELD OF THE INVENTION

The present subject matter relates generally to locks for appliances.

### BACKGROUND OF THE INVENTION

Certain appliances include a cabinet and a door that opens and closes to allow access to an interior of the cabinet. A lock on the door can secure the door in closed position and thereby prevent unauthorized access to the interior of the cabinet. For appliances with locks, the lock must comply with the Refrigeration Safety Act of 1956, which requires the lock to include a mechanism for mechanically disengaging the lock from inside of the cabinet in order to allow an entrapped person to open the door.

Appliances must comply with regulations, but consumer trends have increased the requirements for new appliance designs. For instance, increased food delivery is a current trend. Known appliances for receiving delivery food can include a sealed system for keeping delivered food cold or a heating element for keeping the delivered food hot, but such appliances generally do not include a lock due to the difficulty of allowing a deliverer to open the lock while also meeting regulatory requirements.

### BRIEF DESCRIPTION OF THE INVENTION

Aspects and advantages of the invention will be set forth in part in the following description, or may be apparent from the description, or may be learned through practice of the invention.

In one example embodiment, an appliance includes a cabinet that defines an interior chamber. A door is mounted to the cabinet. A lock assembly is configured to selectively secure the door in a closed arrangement. The lock assembly includes a first latch arm rotatably mounted on the cabinet and a second latch arm rotatably mounted on the door. A handle is positioned within the interior chamber of the cabinet. The handle is coupled to one of the first and second latch arms such that the one of the first and second latch arms is rotatable with the handle. A motor is coupled to the other of the first and second latch arms such that the other of the first and second latch arms is rotatable with the motor.

In another example embodiment, a refrigerated appliance includes an insulated cabinet that defines an interior chamber and an opening. A sealed system is operable to transfer heat from the interior chamber of the insulated cabinet. A door is rotatably mounted to the insulated cabinet at the opening of the insulated cabinet. A lock assembly is configured to selectively secure the door in a closed arrangement over the opening of the insulated cabinet. The lock assembly includes a first latch arm rotatably mounted on the insulated cabinet and a second latch arm rotatably mounted on the door. A handle is positioned within the interior chamber of the insulated cabinet. The handle is coupled to one of the first and second latch arms such that the one of the first and second latch arms is rotatable with the handle. A motor is coupled to the other of the first and second latch arms such that the other of the first and second latch arms is rotatable with the motor.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of an appliance according to an example embodiment of the present disclosure.

FIG. 2 is a section view of the example appliance of FIG. 1.

FIG. 3 is a partial, section view of the example appliance of FIG. 1 and shows a lock according to an example embodiment of the present subject matter.

FIGS. 4 through 6 are perspective views of the example lock of FIG. 3 with latch arms of the example lock shown in various operating positions.

FIG. 7 is another perspective view of the example lock of FIG. 3.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

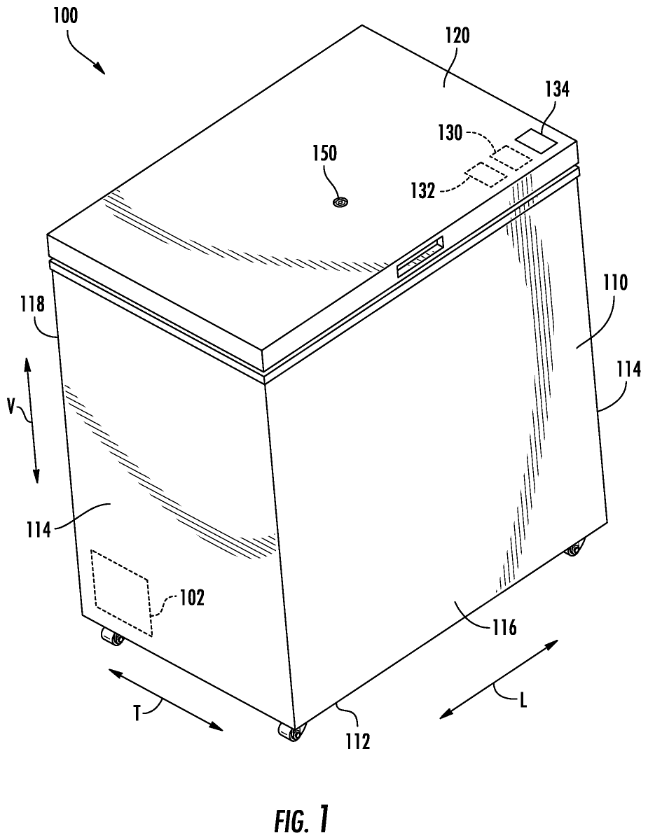

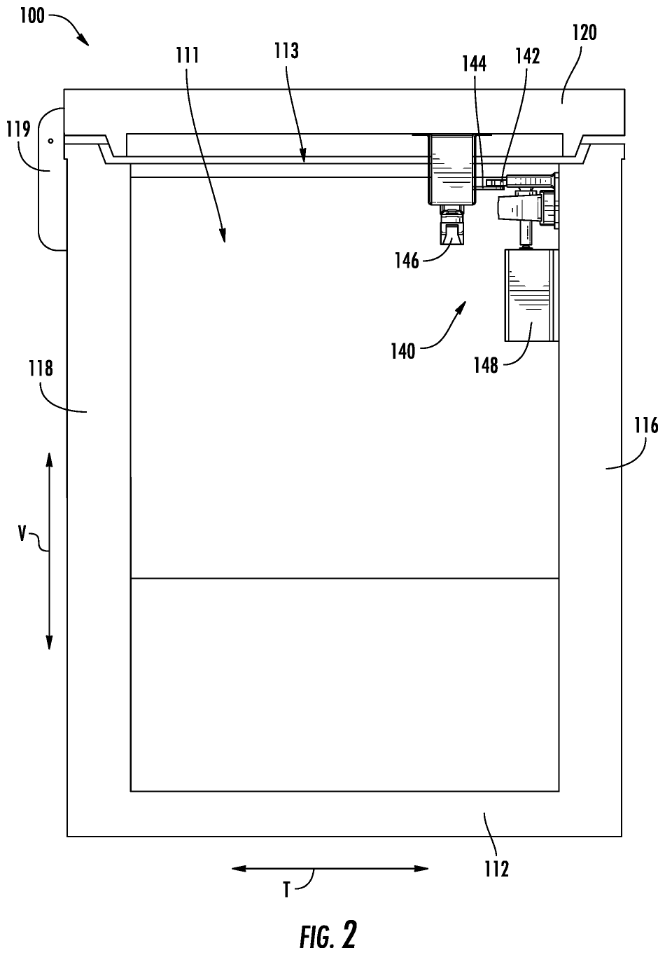

With reference to FIGS. 1 and 2, an appliance 100 according to an example embodiment of the present subject matter is shown. Appliance 100 may be configured for receipt of food articles for storage. For instance, appliance 100 may be positioned at an exterior location, and a deliverer may place groceries, meal(s), etc. within appliance 100 for storage. A user may then retrieve the items from within appliance 100 at a later time, e.g., when the user arrives home. Appliance 100 may define a vertical direction V, a lateral direction L, and a transverse direction T. The vertical direction V, lateral direction L, and transverse direction T may be mutually perpendicular and form an orthogonal direction system.

Appliance 100 may include a cabinet 110. Cabinet 110 may define an interior chamber 111 for storage of items within cabinet 110. Cabinet 110 is generally configured for containing and/or supporting various components of appliance 100 and which may also define one or more internal chambers or compartments of appliance 100. In this regard, as used herein, the terms “cabinet,” “housing,” and the like are generally intended to refer to an outer frame or support structure for appliance 100, e.g., including any suitable number, type, and configuration of support structures formed from any suitable materials, such as a system of elongated support members, a plurality of interconnected panels, or some combination thereof. It should be appreciated that cabinet 110 does not necessarily require an enclosure and may simply include open structure supporting various elements of appliance 100. By contrast, cabinet 110 may enclose some or all portions of an interior of cabinet 110. It should be appreciated that cabinet 110 may have any suitable size, shape, and configuration while remaining within the scope of the present subject matter.

Cabinet 110 may include insulated walls. For instance, cabinet 110 may include a bottom wall 112, sidewalls 114, a front wall 116, and a rear wall 118. Sidewalls 114, front wall 116, and rear wall 118 may extend upwardly from bottom wall 112, e.g., along the vertical direction V. Sidewalls 114 may be spaced apart, e.g., along the lateral direction L. Similarly, front wall 116 and rear wall 118 may be spaced apart, e.g., along the transverse direction T. As such, appliance 100 is generally referred to as a chest-freezer style appliance. It is recognized, however, that the benefits of the present disclosure apply to other types and styles of appliances such as, e.g., bottom mount refrigerator appliances, top mount refrigerator appliances, side-by-side style refrigerator appliances, single door refrigerator appliances, etc. Moreover, aspects of the present subject matter may be applied to other appliances as well. Consequently, the description set forth herein is for illustrative purposes only and is not intended to be limiting in any aspect to any particular appliance or configuration.

A door 120 may be mounted to cabinet 110. For example, door 120 may be rotatably mounted to cabinet 110 with hinges 119. Door 120 may be positioned at a top portion of cabinet 110, e.g., and may form a top wall of cabinet 110 when door 120 is closed and positioned against cabinet 110. Thus, door 120 may be configured to permit selective access to interior chamber 111 and facilitate climate control for interior chamber 111. For example, cabinet 110 may define an opening 113 at top portion of cabinet 110 through which interior chamber 111 is accessible. When door 120 is open, door 120 may be positioned such that a user may access interior chamber 111 through opening 113. In particular, door 120 may be rotated away from opening 113 when door 120 is open. Conversely, door 120 may be positioned such that the user cannot access interior chamber 111 through opening 113 when door 120 is closed. In particular, door 120 may be rotated over opening 113 when door 120 is closed.

Operation of the appliance 100 is regulated by a controller 130 that is operatively coupled to components of appliance 100, including sealed system 102. Controller 130 may be positioned in a variety of locations throughout appliance 100. In the illustrated embodiment shown in FIG. 1, the controller is located within Input/output (“I/O”) signals may be routed between controller 130 and various operational components of appliance 100. The components of appliance 100 may be in communication with controller 130 via one or more signal lines or shared communication busses.

Controller 130 can be any device that includes one or more processors and a memory. As an example, in some embodiments, controller 130 may be a single board computer (SBC). For example, controller 130 can be a single System-On-Chip (SOC). However, any form of controller 130 may also be used to perform the present subject matter. The processor(s) can be any suitable processing device, such as a microprocessor, microcontroller, integrated circuit, or other suitable processing devices or combinations thereof. The memory can include any suitable storage media, including, but not limited to, non-transitory computer-readable media, RAM, ROM, hard drives, flash drives, accessible databases, or other memory devices. The memory can store information accessible by processor(s), including instructions that can be executed by processor(s) to perform aspects of the present disclosure.

A network interface 132 may couple appliance 100, e.g., controller 130, to a network such that appliance 100 can transmit and receive information over the network. The network can be any wired or wireless network such as a WAN, LAN, and/or HAN. Network interface 132 can include any circuitry or components for communication over the network. For example, controller 130 can use network interface 132 to communicate with a remote user interface. Network interface 132 may include transmitters, receivers, ports, controllers, antennas, or other suitable components for interfacing with the network.

Appliance 100, e.g., controller 130, may be in communication with a remote user interface via the network. The remote user interface can be any device configured to communicate over the network and allow a user to remotely generate and transmit command signals to controller 130. For example, the remote user interface may be a computer, a smartphone, a tablet, etc. The remote user interface is in communication with controller 130 such that the remote user interface and controller 130 may transmit signals and data therebetween.

A control panel 134 is provided for controlling the mode of operation. For example, control panel 134 includes one or more selector inputs, such as knobs, buttons, touchscreen interfaces, etc. In this regard, the inputs on control panel 134 may be in communication with controller 130. Signals generated in controller 130 may operate appliance 100 in response to selector inputs at control panel 134.

As shown schematically in FIG. 1, appliance 100 may include a sealed refrigeration system 102. Thus, cabinet 110 may contain components for executing a known vapor compression cycle for cooling air within interior chamber 111. The components may include a compressor, a condenser, an expansion device, and an evaporator connected in series and charged with a refrigerant. As will be understood by those skilled in the art, refrigeration system 102 may include additional components, e.g., at least one additional evaporator, compressor, expansion device, and/or condenser. In addition, refrigeration system 102 may be operable as a heat pump to heat air within interior chamber 111. The components and operation of sealed systems is well understood by those of ordinary skill in the art and is not described in detail herein for the sake of brevity.

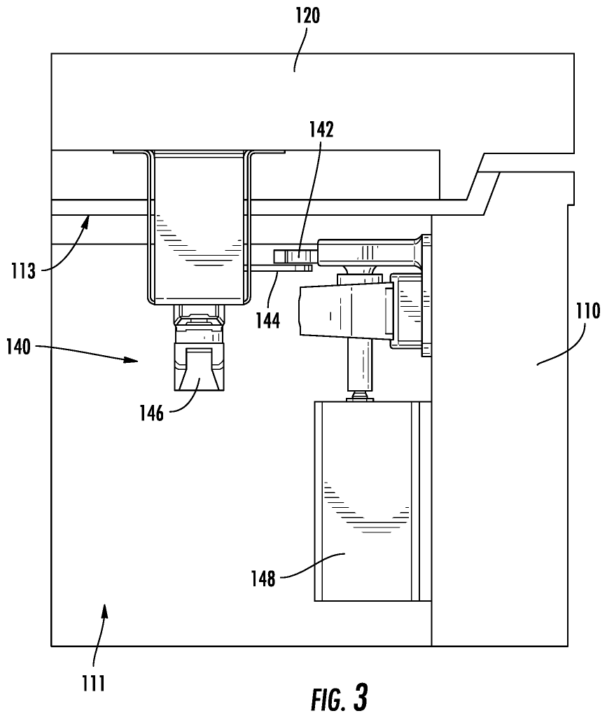

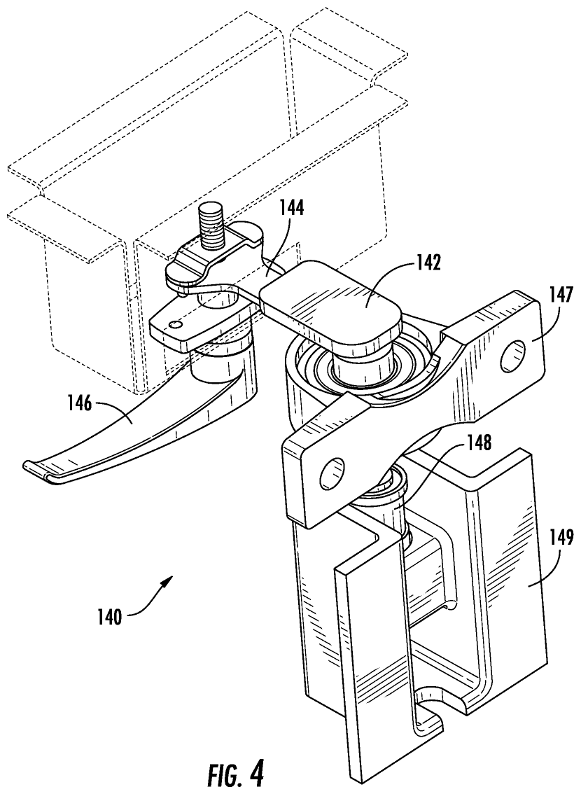

As shown in FIGS. 3 and 4, appliance 100 also includes a lock assembly 140. Lock assembly 140 is configured to selectively secure door 120 in the closed arrangement (shown in FIG. 1). As discussed in greater detail herein, lock assembly 140 includes features for allowing manual actuation of lock assembly 140 from within interior chamber 111. Thus, an individual within interior chamber 111 may actuate lock assembly 140 from within interior chamber 111 in order to open door 120 and escape from cabinet 110.

Lock assembly 140 may include a first latch arm 142 and a second latch arm 144. First latch arm 142 may be rotatably mounted on cabinet 110. Conversely, second latch arm 144 may be rotatably mounted on door 120. Thus, each of first and second latch arms 142, 144 may be positioned on a respective one of cabinet 110 and door 120. Latch arms 142, 144 are rotatable in order to selectively overlap each other. When latch arms 142, 144 overlap (e.g., such that first latch arm 142 is positioned directly over second latch arm 144 along the vertical direction V) and door 120 is closed, first and second latch arms 142, 144 may interlock and prevent door 120 from moving away from the closed position. Conversely, when one or both of latch arms 142, 144 are rotated away and do not overlap (e.g., such that first latch arm 142 is not positioned directly over second latch arm 144 along the vertical direction V), first and second latch arms 142, 144 may not interlock, and a user may rotate door 120 away from the closed position.

Lock assembly 140 also includes a handle 146. Handle 146 is positioned within interior chamber 111 of cabinet 110, e.g., when door 120 is closed. Thus, handle 146 is accessible to an individual within interior chamber 111 when door 120 is closed. Handle 146 may be coupled to one of first and second latch arms 142, 144, e.g., to a shaft of one of first and second latch arms 142, 144. Thus, the one of first and second latch arms 142, 144 to which handle 146 is coupled may rotate when a user turns handle 146. In such a manner, the user may manually rotate one of first and second latch arms 142, 144 from within interior chamber 111 in order to actuate lock assembly 140 and allow the user to open door 120. Handle 146 may be rotatably mounted on door 120 in certain example embodiments.

Lock assembly 140 further includes a motor 148. Motor 148 may be coupled to the other of first and second latch arms 142, 144. For example, a rotor of motor 148 may be coupled to a shaft of the one of first and second latch arms 142, 144 to which handle 146 is not coupled via a bearing 147. The other of latch arms 142, 144 may be rotatable with motor 148. Thus, the one of first and second latch arms 142, 144 to which motor 148 is coupled may rotate when a user operates motor 148. As a particular example, a deliverer may utilize a remote user interface to request controller 130 to command operation of motor 148 in order to rotate the other of latch arms 142, 144 and thus acuate lock assembly 140. As another example, the deliverer may utilize control panel 134 to request controller 130 to command operation of motor 148 in order to rotate the other of latch arms 142, 144 and thus acuate lock assembly 140. As shown in FIG. 3, motor 148 may be coupled to first latch arm 142, and handle 146 may be coupled to second latch arm 144, in certain example embodiments. Motor 148 may be rotatably mounted on cabinet 110, e.g., such that a stator of motor 148 is fixed to a bracket 149, in certain example embodiments.

With reference to FIGS. 4 through 6, various operating states of lock assembly 200 are shown. As shown, first latch arm 142 may be rotatable between an interlock position and a non-interlock position, e.g., with motor 148, and second latch arm 144 may also be rotatable between an interlock position and a non-interlock position, e.g., with handle 146. As shown in FIG. 4, first and second latch arms 142, 144 interlock when both first latch arm 142 is in the interlock position of first latch arm 142 and second latch arm 144 is in the interlock position of second latch arm 144. Thus, first and second latch arms 142, 144 can interfere and prevent door 120 from rotating open in the configuration shown in FIG. 4. The configuration shown in FIG. 3 may thus be referred to as a locked operating condition of lock assembly 140.

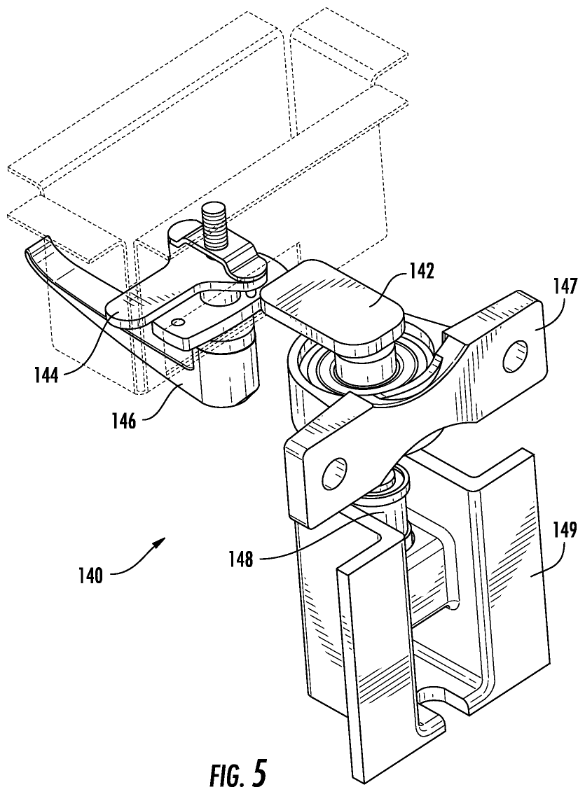

Turning to FIG. 5, handle 146 may be used to rotate second latch arm 144 from the interlock position of second latch arm 144 shown in FIG. 4 to the non-interlock position of second latch arm 144 shown in FIG. 5. When first latch arm 142 is in the interlock position of first latch arm 142 and second latch arm 144 is in the non-interlock position of second latch arm 144, first and second latch arms 142, 144 do not interlock. Thus, first and second latch arms 142, 144 do not interfere and door 120 may rotate open in the configuration shown in FIG. 5. The configuration shown in FIG. 5 may thus be referred to as a manually actuated unlocked operating condition of lock assembly 140.

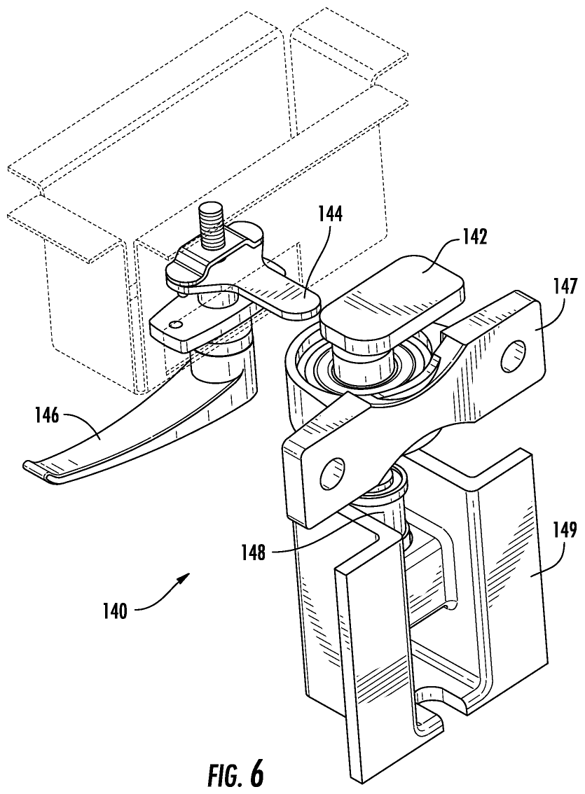

Turning to FIG. 6, motor 148 may be used to rotate first latch arm 142 from the interlock position of first latch arm 142 shown in FIG. 4 to the non-interlock position of first latch arm 142 shown in FIG. 6. When first latch arm 142 is in the non-interlock position of first latch arm 142 and second latch arm 144 is in the interlock position of second latch arm 144, first and second latch arms 142, 144 do not interlock. Thus, first and second latch arms 142, 144 do not interfere and door 120 may rotate open in the configuration shown in FIG. 6. The configuration shown in FIG. 6 may thus be referred to as a motorized actuated unlocked operating condition of lock assembly 140.

It will be understood that both of first and second latch arms 142, 144 may be rotated to the respective non-interlock position of latch arms 142, 144. When both latch arms 142, 144 are in the non-interlock positions, first and second latch arms 142, 144 do not interlock. Thus, first and second latch arms 142, 144 do not interfere and door 120 may rotate open. First and second latch arms 142, 144 may also only rotate via handle 146, motor 148, or some other active actuation. Thus, first and second latch arms 142, 144 may be non-self latching.

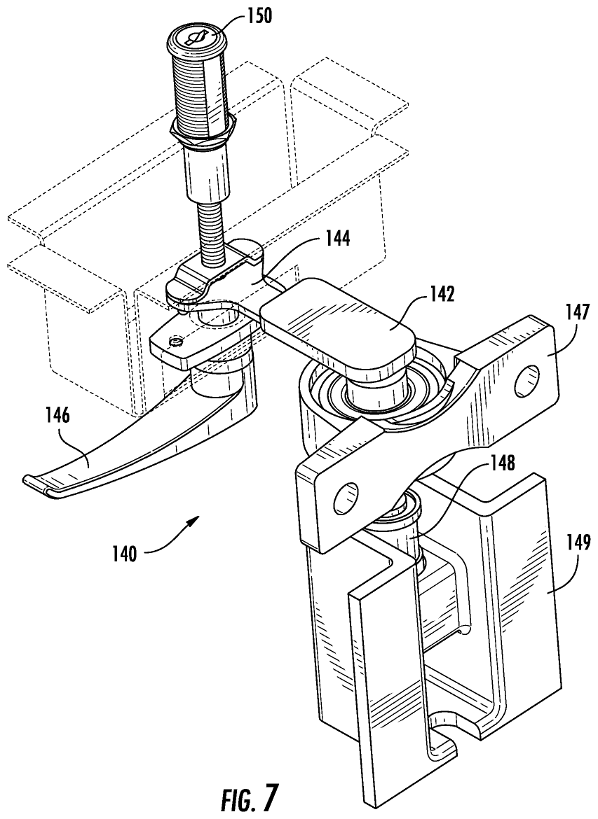

As shown in FIGS. 1 and 7, appliance 100 may also include a keyed pin tumbler lock 150. Keyed pin tumbler lock 150 may be mounted on door 120 and may be coupled to second latch arm 144. Thus, second latch arm 144 may be rotatable with keyed pin tumbler lock 150. For instance, a user may insert a key into keyed pin tumbler lock 150 in order to allow rotation of keyed pin tumbler lock 150. Thus, the user may also rotate second latch arm 144 by inserting the key into keyed pin tumbler lock 150. Keyed pin tumbler lock 150 may thus allow a user of appliance 100 to manual actuate lock assembly 140 from an exterior of cabinet 110. However, by requiring a key, keyed pin tumbler lock 150 may limit such actuation to authorized users.

With the increase in home grocery and package delivery, appliance 100 may provide a climate controller storage location for delivered items. Appliance 100 may be accessed by deliverers to drop off temperature sensitive goods. In particular, appliance 100 may be positioned outside of a desired drop off location. Due to the exterior location of appliance 100 and the requirement to prevent theft of the delivered goods, appliance 100 is equipped to lock assembly 140. Lock assembly 140 may not be self-latching and may be configured for manual actuation of lock assembly from within interior chamber 111 to allow any individual within cabinet 110 to open door 120 from within interior chamber 111. Handle 146 may allow for opening of door 120 in a manner that is intuitive. Motor 148 may also advantageously allow for remote actuation of lock assembly 140, e.g., outside of cabinet 110, e.g., and thus allow deliverers access to interior chamber 111 to drop packages into cabinet 110.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance, comprising:
a cabinet defining an interior chamber;
a door mounted to the cabinet; and
a lock assembly configured to selectively secure the door in a closed arrangement, the lock assembly comprising
a first latch arm rotatably mounted on the cabinet,
a second latch arm rotatably mounted on the door,
a handle positioned within the interior chamber of the cabinet, the handle coupled to one of the first and second latch arms such that the one of the first and second latch arms is rotatable with the handle, and
a motor coupled to the other of the first and second latch arms such that the other of the first and second latch arms is rotatable with the motor.

2. The appliance of claim 1, wherein the motor is coupled to the first latch arm, and the handle is coupled to the second latch arm.

3. The appliance of claim 1, wherein:
the first latch arm is rotatable between an interlock position and a non-interlock position;
the second latch arm is rotatable between an interlock position and a non-interlock position;
the first and second latch arms interlock when both the first latch arm is in the interlock position of the first latch arm and the second latch arm is in the interlock position of the second latch arm; and
the first and second latch arms do not interlock when the first latch arm is in the non-interlock position of the first latch arm, the second latch arm is in the non-interlock position of the second latch arm, or both.

4. The appliance of claim 3, wherein the lock assembly secures the door in the closed arrangement when the first and second latch arms interlock, and the lock assembly does not secure the door in the closed arrangement when the first and second latch arms do not interlock.

5. The appliance of claim 1, wherein the first and second latch arms overlap when the lock assembly secures the door in the closed arrangement.

6. The appliance of claim 1, wherein the door is rotatably mounted to the cabinet with at least one hinge.

7. The appliance of claim 1, further comprising a keyed pin tumbler lock mounted on the door, the keyed pin tumbler lock coupled to the second latch arm such that the second latch arm is rotatable with the keyed pin tumbler lock.

8. The appliance of claim 1, further comprising a sealed system operable to transfer heat from the interior chamber of the cabinet.

9. The appliance of claim 1, further comprising a user interface positioned at an exterior of the appliance, the motor operable to rotate the other of the first and second latch arms in response to an actuating command at the user interface.

10. The appliance of claim 1, further comprising a wireless interface, the motor operable to rotate the other of the first and second latch arms in response to an actuating command received at the wireless interface from a remote user device.

11. A refrigerated appliance, comprising:
an insulated cabinet defining an interior chamber and an opening;
a sealed system operable to transfer heat from the interior chamber of the insulated cabinet;
a door rotatably mounted to the insulated cabinet at the opening of the insulated cabinet; and
a lock assembly configured to selectively secure the door in a closed arrangement over the opening of the insulated cabinet, the lock assembly comprising
a first latch arm rotatably mounted on the insulated cabinet,
a second latch arm rotatably mounted on the door,
a handle positioned within the interior chamber of the insulated cabinet, the handle coupled to one of the first and second latch arms such that the one of the first and second latch arms is rotatable with the handle, and
a motor coupled to the other of the first and second latch arms such that the other of the first and second latch arms is rotatable with the motor.

12. The refrigerated appliance of claim 11, wherein the motor is coupled to the first latch arm, and the handle is coupled to the second latch arm.

13. The refrigerated appliance of claim 11, wherein:
the first latch arm is rotatable between an interlock position and a non-interlock position;
the second latch arm is rotatable between an interlock position and a non-interlock position;
the first and second latch arms interlock when both the first latch arm is in the interlock position of the first latch arm and the second latch arm is in the interlock position of the second latch arm; and
the first and second latch arms do not interlock when the first latch arm is in the non-interlock position of the first latch arm, the second latch arm is in the non-interlock position of the second latch arm, or both.

14. The refrigerated appliance of claim 13, wherein the lock assembly secures the door in the closed arrangement when the first and second latch arms interlock, and the lock assembly does not secure the door in the closed arrangement when the first and second latch arms do not interlock.

15. The refrigerated appliance of claim 11, wherein the first and second latch arms overlap when the lock assembly secures the door in the closed arrangement.

16. The refrigerated appliance of claim 11, wherein the door is rotatably mounted to the insulated cabinet with at least one hinge.

17. The refrigerated appliance of claim 11, further comprising a keyed pin tumbler lock mounted on the door, the keyed pin tumbler lock coupled to the second latch arm such that the second latch arm is rotatable with the keyed pin tumbler lock.

18. The refrigerated appliance of claim 11, further comprising a user interface positioned at an exterior of the appliance, the motor operable to rotate the other of the first and second latch arms in response to an actuating command at the user interface.

19. The refrigerated appliance of claim 11, further comprising a wireless interface, the motor operable to rotate the other of the first and second latch arms in response to an actuating command received at the wireless interface from a remote user device.
